(19) United States
(12) Patent Application Publication
(10) Pub. No.: US 2025/0004443 A1
(43) Pub. Date: Jan. 2, 2025

(54) NUMERICAL CONTROL DEVICE

(71) Applicant: FANUC CORPORATION, Yamanashi (JP)

(72) Inventor: Toshihiro WATANABE, Yamanashi (JP)

(73) Assignee: FANUC CORPORATION, Yamanashi (JP)

(21) Appl. No.: 18/712,275

(22) PCT Filed: Dec. 17, 2021
(86) PCT No.: PCT/JP2021/046736

§ 371 Date: May 22, 2024

(51) Int. Cl. G05B 19/4093; B23Q 15/14

(52) U.S. Cl. CPC G05B 19/4093; B23Q 15/14; G05B 2219/50256

(57) ABSTRACT

The present invention addresses the problem of avoiding uncut portions of a workpiece and interference between a workpiece and a tool attributed to an incorrect movement direction or movement amount of the rotational axis, without changing a program. The numerical control device according to the present invention is a numerical control device for a machine tool that implements machining while changing the relative position and relative orientation between a tool and a workpiece on the basis of a program, the numerical control device comprising: a contour shape generation unit that generates contour shape information pertaining to the contour shape of the workpiece on the basis of relative movement information between the tool and the workpiece described in the program; a relative orientation determination unit that determines a relative orientation of the tool in relation to the workpiece at a change point included in the contour shape information; and a relative orientation change direction determination unit that determines, according to the type of the contour shape, a change direction for the relative orientation in order to obtain the determined relative orientation.

### TECHNICAL FIELD

The present invention relates to a numerical control device.

### BACKGROUND ART

There is known a machine tool (for example, a 5-axis machining center, a composite machining machine, or the like) that machines a workpiece while changing a relative posture of a tool and a workpiece with respect to each other by a cooperative operation of a linear axis and a rotary axis, to perform high-speed machining and/or high-quality machining.

In machining with such a machine tool, a technique is known in which a position of a cutting point and a relative posture are commanded in each block of a program, and a linear axis and a rotation axis are controlled in accordance with these commands and a tool offset set in advance. For example, see Patent Document 1.

### CITATION LIST

### Patent Document

Patent Document 1: Japanese Unexamined Patent Application, Publication No. H5-100723

### DISCLOSURE OF THE INVENTION

### Problems to be Solved by the Invention

However, in Patent Document 1, even if the position of the rotary axis at the start point/end point of each block is correct, when the moving direction (and the moving amount) of the rotary axis is not appropriately set, there is a possibility that interference between the tool and the workpiece or uncut portions of the workpiece may occur.

FIG. 9 shows an example of interference with a workpiece when a multi-edge tool for turning is used. FIG. 9 shows a case of turning with a multi-edge tool for turning along machining paths N1 to N3. In FIG. 9, for example, the linear axes (Z, X) and the B-axis of the multi-edge tool for turning are controlled so that edge 1 of the multi-edge tool for turning always contacts the workpiece.

However, in the conventional art, for example, if the user does not designate in the program that the multi-edge tool for turning is moved in the clockwise direction in accordance with the operation of the circular arc of the machining path N2 from the position P of the end point of the machining path N1 to the position Q of the end point of the machining path N2, the B-axis of the multi-edge tool for turning may be rotated counterclockwise. In this case, as shown in FIG. 9, the multi-edge tool for turning and the workpiece interfere with each other.

FIG. 10 shows an example of a case in which an uncut portion of a workpiece is left by performing swarf machining on a side surface of a truncated cone using a ball end mill. In FIG. 10, for example, the linear axes (X, Y) and the C-axis of the ball end mill are controlled so that the tool side surface of the ball end mill always contacts the side surface of the workpiece.

However, in the conventional art, when making the ball end mill go around the circular arc from position P, for example, if the user does not designate in the program that the C-axis is rotated 360 degrees clockwise in accordance with the operation of the circular arc, as shown in FIG. 10, when the tool tip of the ball end mill reaches the opposite side of the circular arc, the side surface of the tool and the side surface of the workpiece may not contact each other, and the workpiece may not be cut.

As a measure for avoiding the issues shown in FIGS. 9 and 10, a method in which the block is divided into two or more blocks to provide commands, or a method in which the moving amount of the rotary axis is directly commanded as described above is considered, but it takes time to edit and verify the program.

In addition, if this avoidance measure is taken, the program itself becomes complicated, and the capacity of the program memory is wastefully used.

In addition, since the avoidance measure cannot be applied to a command in which a movement command is created in the numerical control device, as in a fixed cycle, the risk of interference may not be avoided.

Therefore, it is desirable to avoid interference between a tool and a workpiece due to an incorrect moving direction or moving amount of a rotary axis and uncut portions of a workpiece, without changing a program.

### Means for Solving the Problems

One aspect of a numerical control device of the present disclosure is a numerical control device for a machine tool that performs machining by changing a relative position and a relative posture of a tool and a workpiece with respect to each other based on a program. The numerical control device includes a contour shape generation unit configured to generate contour shape information on a contour shape of the workpiece based on information on relative movement between the tool and the workpiece described in the program, a relative posture determination unit configured to determine a relative posture of the tool with respect to the workpiece at a change point included in the contour shape information, and a relative posture change direction determination unit configured to determine, according to a type of the contour shape, a change direction of the relative posture to achieve the determined relative posture.

### Effects of the Invention

According to one aspect, it is possible to avoid interference between a tool and a workpiece due to an incorrect moving direction or moving amount of a rotary axis and uncut portions of a workpiece, without changing a program.

### BRIEF DESCRIPTION OF THE DRAWINGS

FIG. 1 is a functional block diagram showing a functional configuration example of a numerical control device according to a first embodiment;

FIG. 2 shows an example of a machining program when a multi-edge tool for turning is used;

FIG. 3 shows an example of a program path (machining path) indicated by the machining program of FIG. 2;

FIG. 4 is a flowchart illustrating the control process of the numerical control device;

FIG. 5 is a functional block diagram showing a functional configuration example of a numerical control device according to a second embodiment;

FIG. 6 shows an example of a machining program when a ball end mill is used;

FIG. 7 shows an example of a program path (machining path) indicated by the machining program of FIG. 6;

FIG. 8 shows an example of a relationship between a traveling direction vector and an offset vector of the ball end mill;

FIG. 9 shows an example of interference with a workpiece when a multi-edge tool for turning is used; and

FIG. 10 shows an example of a case in which an uncut portion of a workpiece is left by performing swarf milling on a side surface of a truncated cone using a ball end mill.

### PREFERRED MODE FOR CARRYING OUT THE INVENTION

A first embodiment and a second embodiment will be described in detail with reference to the drawings.

Here, these embodiments are common in a configuration in which contour shape information on a contour shape of a workpiece is generated based on information on relative movement between a tool and the workpiece described in a program, and a relative posture of the tool with respect to the workpiece is determined based on the generated contour shape information to perform machining.

However, in the first embodiment, a multi-edge tool for turning is used as the tool, and the direction of change of the B-axis of the multi-edge tool for turning is determined according to the type of the contour shape as the relative posture of the multi-edge tool for turning with respect to the workpiece. On the other hand, the second embodiment is different from the first embodiment in that a ball end mill is used as the tool, and the moving direction of the C-axis of the ball end mill is determined according to the type of the contour shape as the relative posture of the ball end mill with respect to the workpiece.

In the following, the first embodiment will be described in detail, and next, portions different from the first embodiment will be mainly described in the second embodiment.

### First Embodiment

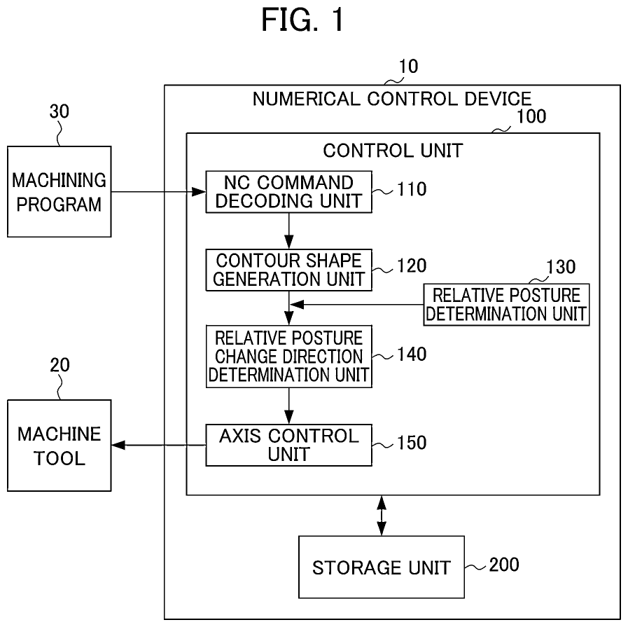

FIG. 1 is a functional block diagram showing a functional configuration example of a numerical control device according to the first embodiment. Here, as described above, the case of using a multi-edge tool for turning as the tool is exemplified. The present invention is not limited to multi-edge tools for turning, and can be applied to any tools.

The case of a circular arc is exemplified as a type of the contour shape. The present invention is not limited to a circular arc, and can be applied to any type of contour shape.

A numerical control device 10 and a machine tool 20 may be directly connected to each other via a connection interface (not shown). The numerical control device 10 and the machine tool 20 may be connected to each other via a network (not shown) such as a LAN (local area network) or the Internet. In this case, the numerical control device 10 and the machine tool 20 are each provided with a communication unit (not shown) for communicating with each other through such a connection.

The numerical control device 10 may be included in the machine tool 20 as described later.

### <Machine Tool 20>

The machine tool 20 is, for example, a 5-axis machining machine or the like that performs machining by changing the relative position and relative posture of a tool known to those skilled in the art and a workpiece with respect to each other, and operates based on commands from the numerical control device 10 described later.

### <Numerical Control Device 10>

The numerical control device 10 is a numerical control device known to those skilled in the art, generates a command based on control information, and transmits the generated command to the machine tool 20. Thus, the numerical control device 10 controls the operation of the machine tool 20.

As shown in FIG. 1, the numerical control device 10 includes a control unit 100 and a storage unit 200. The control unit 100 includes an NC command decoding unit 110, a contour shape generation unit 120, a relative posture determination unit 130, a relative posture change direction determination unit 140, and an axis control unit 150.

### <Storage Unit 200>

The storage unit 200 is a storage unit such as an SSD (solid state drive) or an HDD (hard disk drive). The storage unit 200 stores an operating system, application programs, and the like executed by the control unit 100 described later.

The storage unit 200 may store in advance, for example, shape information on the geometric shape of the multi-edge tool for turning which can be selected in the machine tool 20. Furthermore, the storage unit 200 may store offsets in the X-axis direction and the Z-axis direction of each edge of the multi-edge tool for turning when the B-axis rotating around the Y-axis is “0 degrees” as shape information for each multi-edge tool for turning.

In addition, the storage unit 200 may store the result of analysis of the machining program by the NC command decoding unit 110 described later as information on relative movement as well as contour shape information generated by the contour shape generation unit 120 described later.

### <Control Unit 100>

The control unit 100 includes a CPU, a ROM, a RAM, a CMOS memory, and the like, which are configured to communicate with each other via a bus, and are known to those skilled in the art.

The CPU is a processor that controls the numerical control device 10 as a whole. The CPU reads the system program and the application programs stored in the ROM via the bus, and controls the entire numerical control device 10 in accordance with the system program and the application programs. Thus, as shown in FIG. 1, the control unit 100 is configured to implement the functions of the NC command decoding unit 110, the contour shape generation unit 120, the relative posture determination unit 130, the relative posture change direction determination unit 140, and the axis control unit 150. The RAM stores a variety of data such as temporary calculation data and display data. The CMOS memory is backed up by a battery (not shown), and is configured as a non-volatile memory in which a storage state is held even when the power of the numerical control device 10 is turned off.

The NC command decoding unit 110 acquires a machining program 30 generated by an external device such as a CAD/CAM device, and analyzes the acquired machining program 30. The NC command decoding unit 110 outputs the analysis result as information on relative movement to the contour shape generation unit 120 described later. The NC command decoding unit 110 may store the analysis result in the storage unit 200 as information on relative movement.

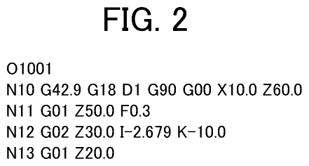

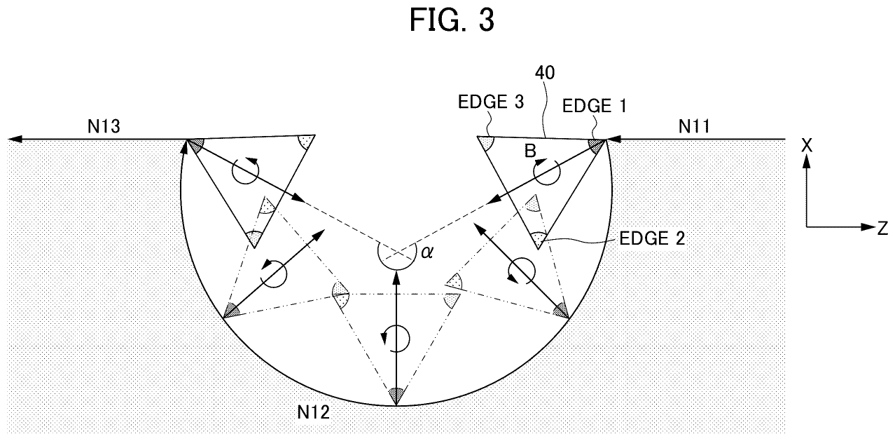

FIG. 2 shows an example of the machining program 30 when a multi-edge tool for turning is used. FIG. 3 shows an example of a program path (machining path) indicated by the machining program 30 of FIG. 2. FIG. 3 illustrates a case where “edge 1” of the multi-edge tool for turning 40 is selected for turning. In FIG. 3, machining paths corresponding to sequence numbers N11 to N13 in the machining program 30 are denoted by N11 to N13, respectively.

As shown in FIG. 2, the machining program 30 is written in G code, and a program name “O1001” is set in the first block.

In the second block of sequence number N10, the position of the tool tip is designated at the address (Z, X) by the ZX plane selection of G18 in the tool posture control mode “G42.9”, and the offset vector of edge 1 indicated by the tool offset number “D1” of the multi-edge tool for turning 40 stored in the storage unit 200 is designated. Thus, the relative posture change direction determination unit 140 described later automatically positions the B-axis of the multi-edge tool for turning 40 according to the path of the machining program 30 so that the designated offset vector (arrow) is orientated in the direction shown in FIG. 3 at each position of the circular arc.

In the third block of sequence number N11, as shown in FIG. 3, edge 1 of the multi-edge tool for turning 40 is cutting fed by “10 mm (=60-50)” in the negative direction of the Z-axis along the machining path N11 at the feed speed “F0.3 (mm/spindle rotation)” in the tool posture control mode “G42.9”.

In the fourth block of sequence number N12, clockwise circular arc interpolation is performed from the end point (50.0, 10.0) of the machining path N11 to the end point (30.0, 10.0) of the machining path N12 with the point (40.0, 7.321), obtained by shifting the end point (50.0, 10.0) of the machining path N11 by −10.0 in the Z-axis direction and by −2.679 in the X-axis direction, as the center of the circular arc in the tool posture control mode “G42.9”. In this case, the relative posture change direction determination unit 140 described later controls the B-axis clockwise during the circular arc interpolation so that the offset vector of edge 1 of the multi-edge tool for turning 40 always overlaps the normal line of the circular arc, as shown in FIG. 3.

In the fifth block of sequence number N13, edge 1 of the multi-edge tool for turning 40 is cutting fed by “10 mm (=30−20)” in the negative direction of the Z-axis along the machining path N13 at the feed speed “F0.3 (mm/spindle rotation)” in the tool posture control mode “G42.9”.

The contour shape generation unit 120 generates contour shape information on the contour shape of the workpiece based on the information on relative movement between the multi-edge tool for turning 40 and the workpiece described in the machining program 30.

Specifically, the contour shape generation unit 120 generates the machining paths N11 to N13 shown in FIG. 3 as the contour shape information, for example, based on the information on relative movement that is the result of analysis by the NC command decoding unit 110. The contour shape generation unit 120 stores the generated contour shape information in the storage unit 200.

The relative posture determination unit 130 determines the relative postures of the multi-edge tool for turning 40 with respect to the workpiece at the change points included in the contour shape information.

Specifically, for example, as shown in FIG. 3, the relative posture determination unit 130 determines the relative posture of the multi-edge tool for turning 40 and the workpiece with respect to each other so that the direction of the offset vector (vector shown by a solid line from the tip of edge 1 of the multi-edge tool for turning 40 to the center of rotation) of the multi-edge tool for turning 40 and the normal line of the circular arc overlap each other at each of the end points of the machining paths N11 and N12, which are the change points included in the contour shape information, and so that the multi-edge tool for turning 40 does not interfere with the workpiece. The relative posture determination unit 130 determines whether the multi-edge tool for turning 40 and the workpiece interfere with each other by using, for example, the shape information of the multi-edge tool for turning 40 stored in the storage unit 200.

The relative posture change direction determination unit 140 determines, for example, according to the type of the contour shape (e.g., a circular arc or the like) between change points (end points of respective blocks or cycles), a change direction of the relative posture to achieve the determined relative posture.

Specifically, for example, the relative posture change direction determination unit 140 automatically determines that the change direction of the B-axis of the multi-edge tool for turning 40 is clockwise (i.e., moves in the negative direction of the B-axis), assuming that the type of the contour shape of the machining path N12 is a clockwise circular arc based on the information on relative movement that is the analysis result of the NC command decoding unit 110.

Since the center angle α of the circular arc of the machining path N12 shown in FIG. 3 is about 210 degrees, the relative posture change direction determination unit 140 determines the change amount of the B-axis of the multi-edge tool for turning 40 as α degrees.

The relative posture change direction determination unit 140 may determine the change amount together with the change direction of the relative posture of the multi-edge tool for turning 40. In this case, the relative posture change direction determination unit 140 may determine the change amount within a range where the multi-edge tool for turning 40 and the workpiece do not interfere with each other.

For example, when the relative posture change direction determination unit 140 determines that the change amount of the B-axis of the multi-edge tool for turning 40 is α+360 degrees×n (n is an integer equal to or greater than 1), the multi-edge tool for turning 40 interferes with the workpiece in the middle of the machining path N12. Therefore, in the case of FIG. 3, the relative posture change direction determination unit 140 automatically determines the change amount of the B-axis of the multi-edge tool for turning 40 as a degrees within a range where the multi-edge tool for turning 40 and the workpiece do not interfere with each other.

When the length of the circular arc of the machining path N12 shown in FIG. 3 is L and the tip speed of edge 1 of the multi-edge tool for turning 40 is V (for example, in the machining program 30 shown in FIG. 2, the feed speed is “F0.3 (mm/spindle rotation)”), the relative posture change direction determination unit 140 may calculate the speed V′ of the B-axis as V′=α×V/L. In this case, when the value of V′ exceeds a predetermined allowable value, the relative posture change direction determination unit 140 may automatically reduce the tip speed V of edge 1 below the feed speed “F0.3 (mm/spindle rotation)”.

Thus, the numerical control device 10 automatically determines the moving direction and the moving amount of the B-axis of the multi-edge tool for turning 40 without directly designating the moving direction and the moving amount of the B-axis of the multi-edge tool for turning 40 by the user in the machining program 30, thereby avoiding interference between the multi-edge tool for turning 40 and the workpiece due to an incorrect moving direction or moving amount of the rotary axis.

Furthermore, the user does not need to divide blocks or directly command the moving amount of the B-axis, which reduces the effort required for program editing and verification.

The axis control unit 150 relatively moves the multi-edge tool for turning 40 or the workpiece, for example, based on the change direction of the B-axis and/or the change amount of the B-axis of the multi-edge tool for turning 40, which is determined by the relative posture change direction determination unit 140.

### <Control Process of Numerical Control Device 10>

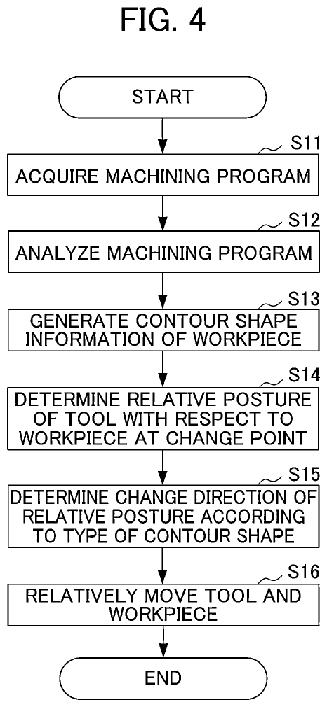

Next, with reference to FIG. 4, the flow of the control process of the numerical control device 10 will be described.

FIG. 4 is a flowchart illustrating the control process of the numerical control device 10. The flow shown here is repeatedly executed every time the machining program 30 is executed.

In Step S11, the NC command decoding unit 110 acquires the machining program 30.

In Step S12, the NC command decoding unit 110 analyzes the machining program 30 acquired in Step S11. Then, the NC command decoding unit 110 outputs the analysis result to the contour shape generation unit 120 as information on relative movement.

In Step S13, the contour shape generation unit 120 generates contour shape information on the contour shape of the workpiece based on the information on relative movement received from the NC command decoding unit 110.

In Step S14, the relative posture determination unit 130 determines the relative posture of the multi-edge tool for turning 40 with respect to the workpiece at a change point (the end point of a machining path) based on the contour shape information generated in Step S13.

In Step S15, the relative posture change direction determination unit 140 determines, according to the type of the contour shape, a change direction of the relative posture of the multi-edge tool for turning 40 to achieve the determined relative posture. The relative posture change direction determination unit 140 calculates the tip speed V of edge 1 of the multi-edge tool for turning 40 so that the speed V′ of the B-axis of the multi-edge tool for turning 40 does not exceed a predetermined allowable value.

In Step S16, the axis control unit 150 relatively moves the multi-edge tool for turning 40 and the workpiece based on the change direction of the relative posture of the tool determined in Step S15.

As described above, the numerical control device 10 according to the first embodiment sets the tool posture control mode “G42.9” in the machining program 30, generates contour shape information on the contour shape of the workpiece, determines the relative posture of the tool with respect to the workpiece at the change point included in the contour shape information, and determines, according to the type of the contour shape, the change direction of the relative posture of the tool to achieve the determined relative posture. Thus, the numerical control device 10 can avoid interference between the tool and the workpiece due to an incorrect moving direction or moving amount of the rotary axis and uncut portions of the workpiece without changing the machining program 30.

Furthermore, since the user does not need to divide blocks or directly command the moving amount of the rotary axis, the effort required for program editing and verification is reduced.

Additionally, since the numerical control device 10 does not need to edit the program, the amount of the program memory to be used does not increase.

The first embodiment has been described above.

### Second Embodiment

Next, a second embodiment will be described. In the first embodiment, the change direction of the B-axis of the multi-edge tool for turning is determined according to the type of the contour shape for the relative posture of the multi-edge tool for turning with respect to the workpiece in the tool posture control mode of “G42.9”. On the other hand, the second embodiment differs from the first embodiment in that the moving direction of the C-axis of the ball end mill is determined according to the type of the contour shape for the relative posture of the ball end mill with respect to the workpiece in the tool posture control mode of “G43.5 P3”.

Thus, a numerical control device 10A according to the second embodiment can avoid interference between the tool and the workpiece due to an incorrect moving direction or moving amount of the rotary axis and uncut portions of the workpiece without changing the program.

The second embodiment will be described below.

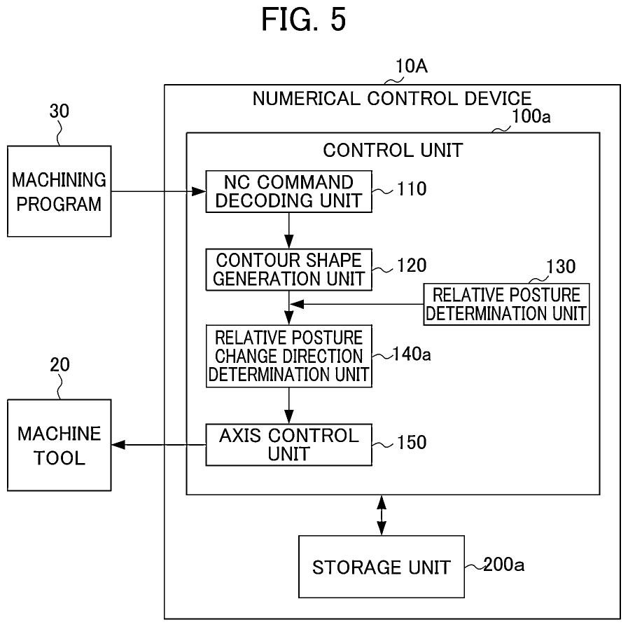

FIG. 5 is a functional block diagram showing a functional configuration example of the numerical control device 10A according to the second embodiment. Note that elements having the same functions as those of the elements of the numerical control device 10 in FIG. 1 are denoted by the same reference numerals, and detailed descriptions thereof are omitted.

The numerical control device 10A and a machine tool 20 may be directly connected to each other via a connection interface (not shown). The numerical control device 10A and the machine tool 20 may be connected to each other via a network (not shown) such as a LAN or the Internet. In this case, the numerical control device 10A and the machine tool 20 are each provided with a communication unit (not shown) for communicating with each other through such connection.

The machine tool 20 has a function equivalent to that of the machine tool 20 in the first embodiment.

### <Numerical Control Device 10A>

As shown in FIG. 5, the numerical control device 10A includes a control unit 100a and a storage unit 200a. The control unit 100a includes a NC command decoding unit 110, a contour shape generation unit 120, a relative posture determination unit 130, a relative posture change direction determination unit 140a, and an axis control unit 150.

<Storage Unit 200a>

The storage unit 200a is a storage unit such as SSD or HDD. The storage unit 200a stores an operating system, application programs, and the like executed by the control unit 100a described later.

Furthermore, the storage unit 200a may store, for example, shape information on the geometric shape of the ball end mill selectable for the machine tool 20 in advance. For example, the storage unit 200a may store the tool length correction amount and the tool holder diameter for each ball end mill as shape information.

<Control Unit 100a>

The control unit 100a includes a CPU, a ROM, a RAM, a CMOS memory, and the like, which are configured to communicate with each other via a bus and are well known to those skilled in the art.

The CPU is a processor that entirely controls the numerical control device 10A. The CPU reads the system program and the application programs stored in the ROM via the bus, and controls the entire numerical control device 10A according to the system program and the application programs. Thus, as shown in FIG. 5, the control unit 100a is configured to realize the functions of the NC command decoding unit 110, the contour shape generation unit 120, the relative posture determination unit 130, the relative posture change direction determination unit 140a, and the axis control unit 150.

The NC command decoding unit 110, the contour shape generation unit 120, the relative posture determination unit 130, and the axis control unit 150 have the same functions as those of the NC command decoding unit 110, the contour shape generation unit 120, the relative posture determination unit 130, and the axis control unit 150 in the first embodiment.

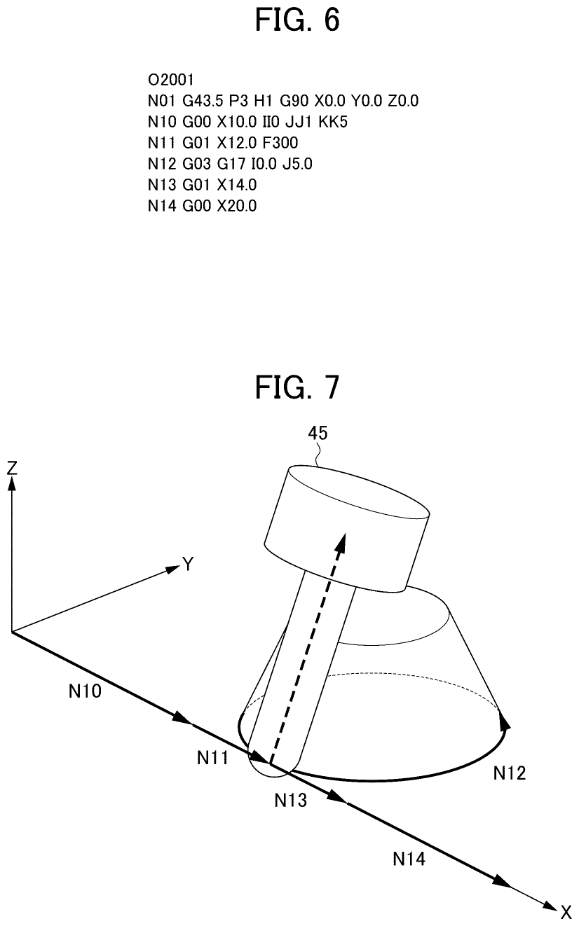

FIG. 6 shows an example of the machining program 30 when a ball end mill is used. FIG. 7 shows an example of a program path (machining path) indicated by the machining program 30 of FIG. 6. FIG. 7 illustrates a case where a ball end mill 45 performs swarf machining on the side surface of a truncated cone based on the machining program 30 shown in FIG. 6. In FIG. 7, program paths (machining paths) corresponding to sequence numbers N10 to N14 in the machining program 30 are denoted by N10 to N14, respectively.

As shown in FIG. 6, the machining program 30 is written in G code, and the program name “02001” is set in the first block.

In the second block of sequence number N01, for example, the tool length correction amount indicated by the tool offset number “H1” of the ball end mill 45 of the shape information stored in the storage unit 200 is used in the side surface machining mode “G43.5 P3” of the tool posture control, the position of the tool tip of the ball end mill 45 is designated by (X, Y, Z), and the offset vector (a vector shown by a broken line from the tool tip to the root of the ball end mill 45) of the ball end mill 45 is designated by (II, JJ, KK). Here, by commanding the side surface machining mode “G43.5 P3” of the tool posture control, as described later, the X and Y coordinates of the center of the circle drawn by the tool tip of the ball end mill 45 and those of the center of the circle drawn by the root of the ball end mill 45 coincide with each other in the block of sequence number N12. Therefore, the side surface machining mode “G43.5 P3” of the tool posture control has the information “side surface of the truncated cone”.

The offset vector (II, JJ, KK) of the ball end mill 45 is designated by sequence number N10 described later.

In the third block of sequence number N10, the tool tip of the ball end mill 45 is rapidly traversed to the position of (10, 0, 0) in the side surface machining mode “G43.5 P3” of the tool posture control, and the direction of the offset vector (a vector shown by a broken line from the tool tip to the root of the ball end mill 45) is set to (0, 1, 5) at the end point of the machining path N10.

In the fourth block of sequence number N11, linear interpolation (cutting feed) is performed at a feed speed of “F300 (mm/min)” to a position of (12, 0, 0) while maintaining the direction of the offset vector at (0, 1, 5) in the side surface machining mode “G43.5 P3” of the tool posture control.

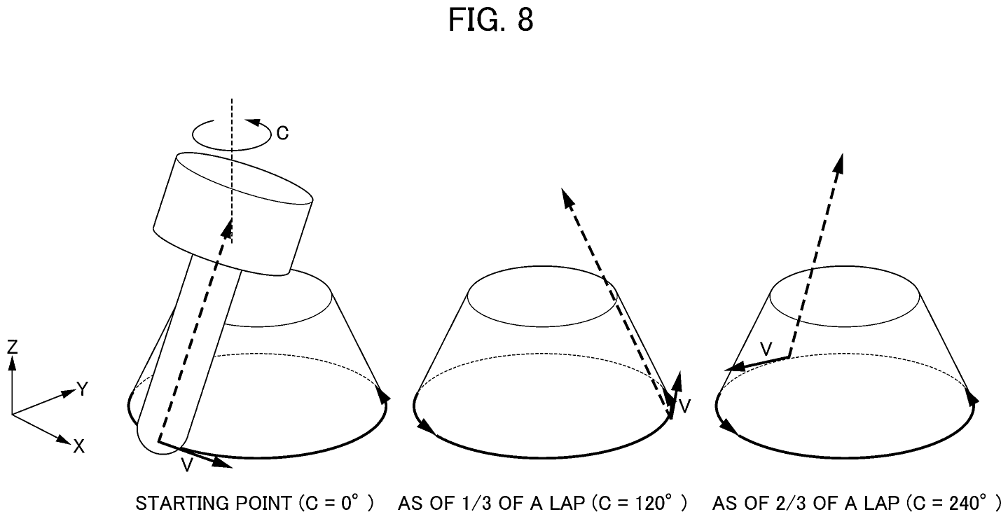

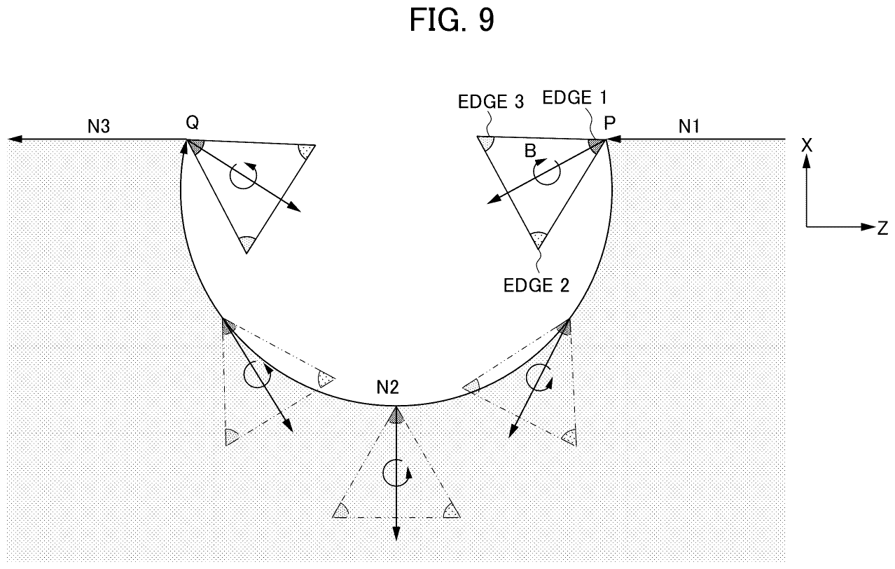

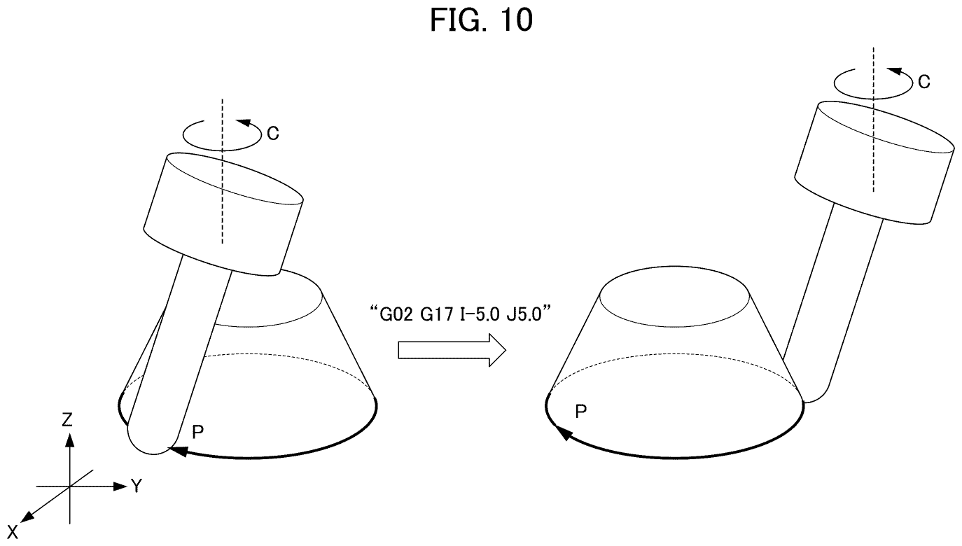

In the fifth block of sequence number N12, counterclockwise circular arc interpolation is performed in the XY plane with a point (12.0, 5.0) obtained by shifting the end point (12.0, 0.0) of the machining path N11 by 0.0 in the X-axis direction and 5.0 in the Y-axis direction as the center position of the circular arc in the side surface machining mode “G43.5 P3” of the tool posture control. In this case, as shown in FIG. 8, the relative posture change direction determination unit 140a described later controls the tip position and the posture (C-axis rotating around the Z-axis) of the ball end mill 45 so that the traveling direction vector V of the tool tip point of the ball end mill 45 and the offset vector (broken line) of the ball end mill 45 are always maintained at the same angle during the circular arc interpolation.

In the sixth sequence number N13, linear interpolation (cutting feed) is performed at a feed speed of “F300 (mm/min)” to a position of (14, 0, 0) while maintaining the direction of the offset vector at (0, 1, 5) in the side surface machining mode “G43.5 P3” of the tool posture control.

In the seventh sequence number N14, rapid traverse is performed to a position of (20, 0, 0) while maintaining the direction of the offset vector at (0, 1, 5) in the side surface machining mode “G43.5 P3” of the tool posture control.

The relative posture change direction determination unit 140a determines, for example, according to the type of a contour shape (for example, a side surface of a truncated cone (swarf machining)) between change points (end points of respective blocks or cycles) a change direction of the relative posture to achieve the determined relative posture.

Specifically, as shown in FIG. 8, the relative posture change direction determination unit 140a assumes that the type of the contour shape of the machining path N12 is the side surface (swarf machining) of the truncated cone in the counterclockwise direction based on the information on relative movement that is the result of analysis by the NC command decoding unit 110, and determines the change direction of the c-axis rotating around the z-axis of the ball end mill 45 so that the traveling direction vector V of the tool tip point of the ball end mill 45 and the offset vector (broken line) of the ball end mill 45 are always maintained at the same angle during the counterclockwise circular arc interpolation in the XY plane of the machining path N12.

That is, since sequence number N12 is a block of counterclockwise circular arc interpolation in the side surface machining mode of the tool posture control of “G43.5 P3”, as shown in FIG. 8, the relative posture change direction determination unit 140a automatically determines that the moving direction (change direction) of the C-axis of the ball end mill 45 is the positive direction.

In addition, since sequence number N12 is a block of exactly circling the circular arc, the relative posture change direction determination unit 140a determines that the moving amount of the C-axis of the ball end mill 45 is 360 degrees. That is, when the moving amount of the C-axis is 0 degrees, 720 degrees, or the like, the ball end mill 45 and the workpiece interfere with each other.

When the length of the circular arc of the machining path N12 shown in FIG. 8 is L and the tip speed (traveling direction vector) of the ball end mill 45 is V (for example, in the machining program 30 of FIG. 6, the feed speed “F300 (mm/min)” is set), the relative posture change direction determination unit 140a may calculate the speed V′ of the C-axis as V′=360 degrees×V/L. In this case, when the value of V′ exceeds a predetermined allowable value, the relative posture change direction determination unit 140a may automatically reduce the tip speed (traveling direction vector) V of the ball end mill 45 below the feed speed “F300 (mm/min)”.

Thus, the numerical control device 10A automatically determines the moving direction and the moving amount of the C-axis of the ball end mill 45 without directly designating the moving direction and the moving amount of the C-axis of the ball end mill 45 by the user in the machining program 30, thereby avoiding interference between the ball end mill 45 and the workpiece due to an incorrect moving direction or moving amount of the rotary axis.

Furthermore, since the user does not need to divide blocks or directly command the moving amount of the C-axis, the effort required for program editing and verification is reduced.

Note that the control process of the numerical control device 10A is the same as in the case of FIG. 4, and a detailed description thereof will be omitted.

As described above, the numerical control device 10A according to the second embodiment sets the side surface machining mode of the tool posture control of “G43.5 P3” in the machining program 30, generates contour shape information on the contour shape of the workpiece, determines the relative posture of the tool with respect to the workpiece at the change point included in the contour shape information, and determines, according to the type of the contour shape, the change direction of the relative posture of the tool to achieve the determined relative posture. Thus, the numerical control device 10A can avoid interference between the tool and the workpiece due to an incorrect moving direction or moving amount of the rotary axis and uncut portions of the workpiece, without changing the machining program 30.

Furthermore, since the user does not need to divide blocks or directly command the moving amount of the rotary axis, the effort required for program editing and verification is reduced.

Additionally, since the numerical control device 10A does not need to edit the program, the amount of the program memory to be used does not increase.

The second embodiment has been described above.

Although the first embodiment and the second embodiment have been described above, the numerical control devices 10 and 10A are not limited to the above-described embodiments, and include modifications, improvements, and the like within a range where the object can be achieved.

### <Modification 1>

In the first and second embodiments, the numerical control devices 10 and 10A are different devices from the machine tool 20, but the present invention is not limited thereto. For example, the numerical control devices 10 and 10A may be included in the machine tool 20.

### <Modification 2>

For example, in the first and the second embodiments, the multi-edge tool for turning 40 or the ball end mill 45 is used as the tool, but the tool is not limited thereto. For example, the present invention can be applied to any tool.

The functions included in the numerical control devices 10 and 10A in the first and second embodiments can be implemented by hardware, software, or a combination thereof. Here, “implemented by software” means implementation by a computer reading and executing a program.

The program may be stored and provided to a computer using various types of non-transitory computer readable media. The non-transitory computer readable media include various types of tangible storage media. Examples of the non-transitory computer readable media include magnetic recording media (e.g., flexible disks, magnetic tapes, hard disk drives), magneto-optical recording media (e.g., magneto-optical disks), CD-ROMs (read only memories), CD-Rs, CD-R/Ws, and semiconductor memories (e.g., mask ROMs, PROMS (programmable ROMs), EPROMS (erasable PROMs), flash ROMs, and RAMs). The program may also be provided to a computer by various types of transitory computer readable media. Examples of the transitory computer readable media include electrical signals, optical signals, and electromagnetic waves. The transitory computer readable media can provide the program to the computer via a wired communication path, such as an electric wire or an optical fiber, or a wireless communication path.

Note that the steps of describing the program recorded in the recording medium include not only the processing performed in time series along the order but also the processing performed in parallel or individually without necessarily being processed in time series.

In other words, the numerical control device of the present disclosure can take various embodiments having the following configurations.

(1) A numerical control device 10, 10A of the present disclosure is a numerical control device for a machine tool 20 that performs machining by changing a relative position and a relative posture of a tool and a workpiece with respect to each other based on a machining program 30. The numerical control device includes a contour shape generation unit 120 configured to generate contour shape information on a contour shape of the workpiece based on information on relative movement between the tool and the workpiece described in the machining program 30, a relative posture determination unit 130 configured to determine a relative posture of the tool with respect to the workpiece at a change point included in the contour shape information, and a relative posture change direction determination unit 140, 140a configured to determine, according to a type of the contour shape, a change direction of the relative posture to achieve the determined relative posture.

According to the numerical control device 10, 10A, it is possible to avoid interference between the tool and the workpiece due to an incorrect moving direction or moving amount of the rotary axis and uncut portions of the workpiece without changing the program.

(2) In the numerical control device 10, 10A according to (1), the relative posture determination unit 130 may determine the relative posture by using a value commanded by the machining program 30 or by calculation based on the contour shape.

Thus, the numerical control device 10, 10A can easily determine the relative posture.

(3) In the numerical control device 10, 10A according to (1) or (2), the relative posture change direction determination unit 140, 140a may determine the change direction of the relative posture and/or a change amount of the relative posture within a range where the tool and the workpiece do not interfere with each other when the tool and the workpiece relatively move along the contour shape.

Thus, the numerical control device 10, 10A can maintain the machining quality of the workpiece.

(4) In the numerical control device 10, 10A according to any one of (1) to (3), the relative posture change direction determination unit 140, 140a may control the tool and/or the workpiece not to move at a predetermined speed or higher when relatively moving the tool and the workpiece in accordance with the determined change direction of the relative posture. Thus, the numerical control device 10, 10A can maintain the machining quality of the workpiece and suppress the deterioration of the tool.

### EXPLANATION OF REFERENCE NUMERALS

10, 10A numerical control device
100, 100a control unit
110 NC command decoding unit
120 contour shape generation unit
130 relative posture determination unit
140, 140a relative posture change direction determination unit
150 axis control unit
200, 200a storage unit
20 machine tool
30 machining program
40 multi-edge tool for turning
45 ball end mill

1. A numerical control device for a machine tool that performs machining by changing a relative position and a relative posture of a tool and a workpiece with respect to each other based on a program, the numerical control device comprising:
a contour shape generation unit configured to generate contour shape information on a contour shape of the workpiece based on information on relative movement between the tool and the workpiece described in the program;
a relative posture determination unit configured to determine a relative posture of the tool with respect to the workpiece at a change point included in the contour shape information; and
a relative posture change direction determination unit configured to determine, according to a type of the contour shape, a change direction of the relative posture to achieve the determined relative posture.

2. The numerical control device according to claim 1, wherein the relative posture determination unit determines the relative posture by using a value commanded by the program or by calculation based on the contour shape.

3. The numerical control device according to claim 1, wherein the relative posture change direction determination unit determines the change direction of the relative posture and/or a change amount of the relative posture within a range where the tool and the workpiece do not interfere with each other when the tool and the workpiece relatively move along the contour shape.

4. The numerical control device according to claim 1, wherein the relative posture change direction determination unit controls the tool and/or the workpiece not to move at a predetermined speed or higher when relatively moving the tool and the workpiece in accordance with the determined change direction of the relative posture.
